(19) United States
(12) Patent Application Publication
(10) Pub. No.: US 2005/0036731 A1
(43) Pub. Date: Feb. 17, 2005

(54) Method of optical fibre preform manufacture

(75) Inventor: Ian Andrew Maxwell, Five Dock, New South Wales (AU)

Correspondence Address: NIXON PEABODY, LLP, 401 9TH STREET, NW, SUITE 900, WASHINGTON, DC, 20004-2128, US

(73) Assignee: Cactus Fiber Pty Limited Australian Technology Park, Eveleigh New South Wales (AU)

(21) Appl. No.: 10/478,493

(22) PCT Filed: May 22, 2002
(86) PCT No.: PCT/AU02/00638

(30) Foreign Application Priority Data
May 22, 2001 (AU) PR 5182

(51) Int. Cl. G02B 6/26; G02B 6/42

(52) U.S. Cl. 385/16

(57) ABSTRACT

The present invention provides a method for producing a perform (1) for a holey optical fibre including thermomechanically forming the preform from a unitary body of optically suitable material (20) so that one or more discrete optical elements (30), such as air holes, are formed therein. Each element (30) has a refractive index which is different from the refractive index of the optically suitable material (20). The thermomechanical formation is preferably conducted by extrusion or by injection molding. In a preferred embodiment, the unitary body is a fluid. The method is suitable for production of a preform for a polymer holey optical fibre or an inorganic glass holey optical fibre.

### TECHNICAL FIELD

The present invention relates to the production of optical fibres and in particular but not only to crystal optical fibres.

### BACKGROUND OF THE INVENTION

Any discussion of the prior art throughout the specification should in no way be considered as an admission that such prior art is widely known or forms part of common general knowledge in the field.

In the late 1990's, Philip Russell from the University of Bath, United Kingdom and his co-workers developed optical fibres which comprised micro structured silica with a series of several hundred air holes running along its length.

These fibres were sometimes referred as holey fibres and more lately as crystal fibres due to the complex lattice microstructure of the air holes. Technically, such holey or crystal fibres do not include a ‘core’ or ‘cladding’ as the terms are used when referring to conventional graded index optical fibres. In the art, however, the term ‘cladding’ is sometimes used to refer to the microstructure or lattice of air holes, of the ‘core’ being a reference to the defect or irregularity in this microstructure lattice, ie absence of an air hole through which the fibre transmits light. The first generation of fibres used a simple repeating triangular arrangement of air holes, with a single missing air hole forming the defect through which light was transmitted. More complex structures have now been developed.

Originally, Russell and his team developed the fibres to exploit photonic band gap effect. However, it was soon realised that the fibres also operated by simple index guidance due to the high refractive index of the core region or defect compared to the effective index of the surrounding air holes or cladding microstructure.

While the performance of crystal fibres via index guiding is well known, their use for transmission via the photonic band gap effect is not as well known. In particular, the size, shape and layout of the air holes must be strictly controlled to first realise and enhance transmission by photonic band gap.

Conventional crystal fibres are commonly fabricated by bundling an array of silica (glass) rods and tubes to form the preform. This preform is then drawn into a fibre using a conventional tower set up. The stack and draw process does generally provide the crystal fibre with regular air hole arrangements. These can be quite varied including triangular or hexagonal arrangements, honeycomb type arrangements etc.

These crystal fibres, however, have extremely close tolerances. In many cases, the centre to centre spacing of two nearest air holes will be less than a few microns. Accordingly, it would be useful to have an improved production method which not only provides more consistent results but which allows more varied arrangement of the fibre.

It is an object of the present invention to overcome or ameliorate at least one of the disadvantages of the prior art, or to provide a useful alternative.

### DISCLOSURE OF THE INVENTION

In a first aspect, the present invention provides a method of producing a preform for a holey optical fibre, said fibre having one or more light transmitting region(s) therethrough, said method comprising thermomechanically forming said preform from a unitary body of an optically suitable material such that one or more discrete optical elements are formed therein, each element having a refractive index which is different from the refractive index of the optically suitable material.

In a second aspect, the present invention provides a method of producing a holey optical fibre comprising thermomechanically altering a unitary body of optically suitable material to form an optical fibre having one or more light transmitting regions including one or more discrete optical elements therein, each optical element having a refractive index which is different from the refractive index of the optically suitable material.

The present invention is particularly suitable for producing polymer holey fibres, however, other material such as inorganic glass fibres may also be constructed using this technique. The unitary body may be formed from a variety of materials, for example inorganic glasses such as so called “soft glasses” or mono/poly/oligomeric materials.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

As discussed above, in a crystal or holey fibre, the cladding region is formed by a regular lattice or microstructure of discrete optical elements, eg air holes. The core region is normally surrounded by such a microstructure. The core is sometimes referred to as the defect or irregularity in the microstructure, ie a missing air hole, which allows light to pass therethrough.

In a preferred embodiment, the unitary body is a fluid. For instance, most mono/poly/oligomeric materials and inorganic glasses are provided in a particulate form. Accordingly, the unitary body of optically suitable material may be obtained by providing said material in a particulate form and melting the material to obtain the fluid unitary body. The thermomechanical formation is preferably conducted by extrusion or by injection moulding. The proposed method provides great flexibility in the construction of both preforms and the resultant optical fibres drawn from those preforms.

In one embodiment, the discrete elements have a refractive index which is less than the refractive index of the surrounding preform or fibre material.

The above described technique and its preferred embodiments provides a number of significant advantages over the prior art. They include the opportunity to produce holey fibre preforms with discrete elements, eg air holes, of various shapes and sizes, complex fibre shapes which are currently difficult or expensive to produce using conventional techniques, eg multiple core structures, ability to produce holey fibres from a wide range of optically suitable materials than is currently used, a more efficient mechanism for producing holey optical fibres and preforms, and the opportunity to provide continuous production of such products.

There have previously been proposed extrusion like systems for producing gradient index fibres or indeed step index fibres. The gradient index fibres, however, are difficult to produce. Most involve extremely complex co-extrusion techniques whereby multiple layers are formed throughout the product each layer having a different refractive index.

Some processes use even more complex production techniques involving addition or removal of certain materials pre or post the extrusion die to alter refractive indexes, or treatment of the fibre. Techniques for polymer fibres involve physical movement or rotation of polymeric/monomeric materials to selectively mix and deposit the resultant mixture at the right position in the fibre.

Almost invariably, these techniques are exceedingly complex to construct and control, particularly due to possible diffusion of materials during the extrusion or injection moulding processes.

Extrusion techniques have been proposed to produce preforms for silica or glass based holey fibres. As will be clear to persons skilled in the art, however, glass typically used for holey fibres has a melting point, well over 500° C. This causes the significant additional cost and handling problems in attempting extrusion. It is possible to use softer glasses or polymeric materials to address this problem

Typical glass based fibres require sintering step after extrusion and this an added complication.

With extrusion of typical fibre glasses, it is vital that the refractive index and thermomechanical properties of the glass remain unchanged or at least uniform through the extrusion process. With the present invention on the other hand, this is not necessarily the case. Indeed, the flexibility of the present invention allows an operator to select a material which is suitable for thermomechanical forming, eg extrusion or injection moulding, and then if necessary apply further processing to arrive at the most suitable material from an optical transmission perspective. For example, an operator may determine that it is most suitable to extrude a monomeric material, cure the material by an appropriate technique, eg photo curing, optionally anneal the resultant curing material and draw it into a fibre.

The discrete elements included within the preform or fibre may be of any size shape or orientation required. In line with conventional holey optical fibres, the discrete elements may be provided by air holes running the length of the fibre. Alternatively, the discrete elements may be evacuated, or filled with other gas or liquid or in some cases provided by semi-conductor or materials conductive materials. In still another embodiment, the discrete elements may be provided by monomeric, polymeric or other optical material, eg glass or silica containing material, which has a different refractive index than the refractive index of the surrounding material.

The abovementioned method is suitable for producing holey optical fibres suitable for transmitting light/data by index guidance or photonic band gap effect.

In another aspect, the present invention provides a method of producing an optical fibre comprising producing a preform as discussed above and drawing the preform to a fibre.

In a further aspect, the present invention provides a preform or holey fibre or waveguide produced by the above method(s).

Additionally, the inventive method can be used to not only form the preform or fibre, but also a protective material on the exterior of the optical fibre core, thereby forming a complete holey fibre or waveguide. A preform can be extruded with an exterior polymer coating which acts as a protective coating for the fibre. Protective coatings are usually applied whilst a fibre is being drawn from a pre-form, via a process of immersion of the drawn fibre through a bath containing material that makes up the coating, and subsequent UV-curing or heat curing (polymerisation) of these molecules to form a protective polymer. The addition of a protective coating to the pre-form removes the need for this extra process step, and greatly simplifies the production process, whilst also removing a constraining factor in the fibre manufacturing process.

The production of such holey or crystal fibres by thermomechanical alteration of a unitary body is possible since the development of processes for producing, for example, polymer optical fibres using a single polymer phase. In the present inventive technique however, the refractive index is modified not by dopants or complex multi-polymer co-extrusion techniques but rather by the use of the discrete optical elements, eg air holes and hence a single phase optical material such as polymer, soft glass etc can be used.

### BEST MODE FOR CARRYING OUT THE INVENTION

So that the present invention may be more clearly understood, it will now be described by way of example only with reference to the following embodiments and drawings, in which:

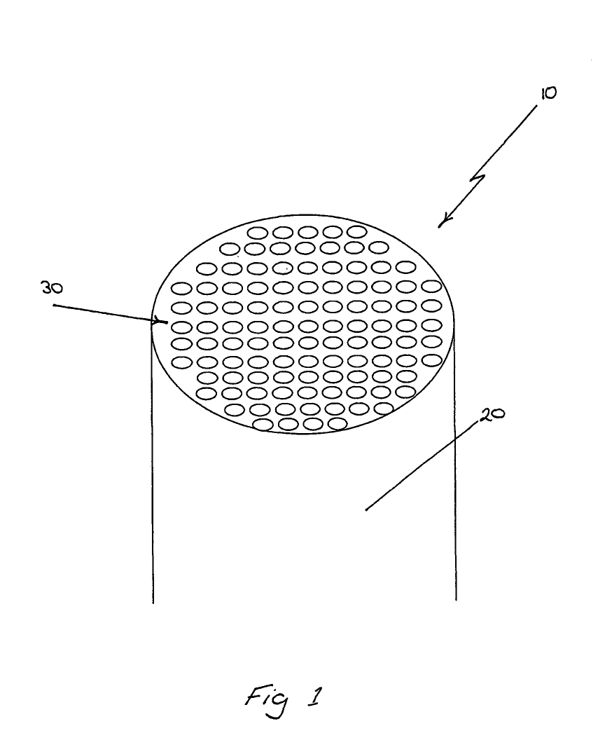

FIG. 1 is a schematic view of a preform produced in accordance with a first embodiment of the present invention,

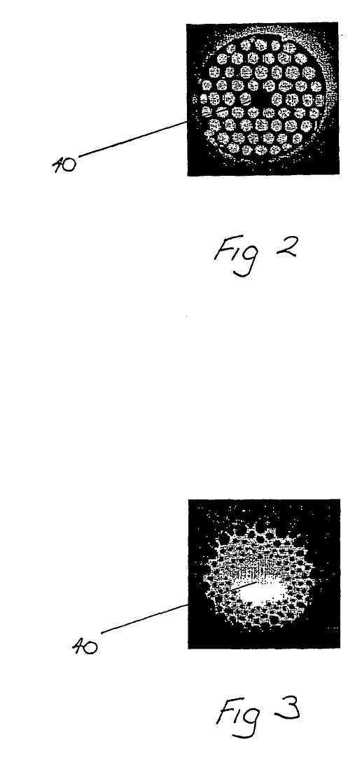

FIG. 2 is a micrograph of a fibre produced in accordance with another embodiment of the present invention, and

FIG. 3 is a micrograph of still a further fibre produced in accordance with a further embodiment of the present invention.

By extrusion, injection moulding or similar thermomechanical techniques, an infinite number of arrangements of the core region and cladding region in the preform and consequently in the holey fibre can be produced. If the discrete elements are air holes, for example, they may be provided by simple absence of optical fibre material, or alternatively using a blank which can later be removed from the resultant crystal fibre.

The thermomechanical forming of plastics being in monomeric or polymeric form is a mature art and there are a wide variety of techniques and apparatus such as extrusion dies and injection moulding apparatus which a person skilled in the art may use to prepare the above mentioned preforms and fibres. These techniques may also be applied to soft glasses.

For instance, in extrusion moulding, a die may be configured to provide a preform of optically suitable material with a series of air holes therethrough. Either rigid or fluid lumens can be positioned within the die to produce the aforementioned air holes. In a particularly preferred embodiment, such lumens are variable to alter the position of the air hole and thereby change the resultant characteristics of the fibre.

In addition, unlike the prior art, the size, shape and orientation of the discrete elements eg air holes can also be altered. With conventional techniques, the air holes must ordinarily be circular in shape. The present inventive technique allows air holes of any shape and further allows the air holes to be positioned anywhere in the core or cladding structure.

Of course, if the discrete optical elements within the fibre are not air holes but, for example, filled with another optically suitable material, the extrusion die may be configured to have several injection points for such elements.

Still further, the present inventive technique will also allow the cross-sectional shape and size of the discrete elements to either remain constant or vary along the length of the optical fibre. In the prior art, the air holes are of constant cross section. While this has some advantages, it is envisaged that there may be reasons for altering the cross section of the air holes along the length of the crystal fibre. For example, the air holes may taper or diverge once or several times along its length.

Similarly, the relative cross-sectional position of the discrete optical elements may remain constant or vary along the length of the fibre. With conventional holey fibres, the air holes run substantially parallel to the axis of the fibres. No such limitation exists with the inventive technique. For example, it is within the scope of the inventive method to extrude a holey fibre or preform with air holes which are not parallel to the optical fibre axis. There may be applications where air holes intersect or spiral around the axis etc. In particular, there can be difficulties associated with conventional holey fibres having air holes running the length of the optical fibre since, when the optical fibre is bent, one side of the air hole is in compression and one side is in tension. The size and shape of the discrete optical elements can be arranged to counter the stress induced change to the refract index. The stress profile may be reduced by altering the size and number of the air holes or by running a spiral or helical air holes along the length of the fibre.

It should also be appreciated that it is not necessary for the discrete optical elements to run the entire length of the fibre. There may be applications where the discrete elements are provided as pockets or finite length elements embedded in the core or cladding region.

In most cases, the form of the extruded or moulded preform will be maintained after it is removed from a die or mould. In some instances, however, it may be desired to alter the shape in a known and intended way after the material leaves the die or mould, eg reduction by solvent removal, increase in size by inflation, etc.

This process, when used to produce polymer holey optical fibres, can also be used in conjunction with selective curing techniques. Curing can be accomplished by conventional methods such as bulk polymerisation or new techniques such as selective photocuring, application of heat, pressure etc.

By co-extrusion or injection moulding heterogeneous holey fibres or preforms may be produced, ie layers or areas of different optical materials. For instance, extrusion of a single monomer may be followed by selective polymerisation of certain areas to alter the refractive index. Alternatively, mixtures of various monomers/polymers/oligomers with different refractive indices may be provided directly to the extrusion die or mould. Different refractive indices may be provided by different dopants in the monomer/polymer applied to the die. Very complex fibres can also be manufactured using this process even allowing for heterogeneity along the length of the fibre or preform. The discrete elements can be created within the fibre by leaving voids, or by extruding/moulding dummy materials in the relevant position, eg using the ‘wax method’ whereby the formed wax elements or other material is removed from the preform after extrusion/moulding to thereby leave the desired air holes.

It is also envisaged that materials other than monomeric/polymeric/oligomeric or soft glasses may be incorporated into the optically suitable material used to produce the preform. For instance, particles of other materials such as semi-conductor material, may be incorporated provided it does not substantially alter the thermomechanical properties of the optically suitable material.

The construction technique also allows for fibre shapes to be controlled. At the present time, complex fibre shapes require specialised manufacturing techniques. By use of die extrusion or injection moulding it is possible to manufacture the preform or optical fibre in any shape desired. Additionally, multiple cores can be produced within a single fibre. The extent to which refractive indices, shapes, sizes or core, cladding and discrete elements can be altered by means of this technique are almost limitless.

In this regard, a key benefit of this new technology is the ability to make specific holey optical fibres for photonic components. As the use of holey fibres expands, especially in local area networks, there will be an increased demand for components that are analogues to those used in silica based optical fibre networks. These include, circulators, couplers, modulators, gratings, amplifiers and the like. The ability to produce holey fibres in any material with any refractive index profile and/or shape will not only permit the construction of these holey fibre components, it will allow the construction of optical components that do not currently exist due to limitations of holey fibre construction techniques, including those used to make silica based optical fibres.

The present inventive process also provides for the opportunity to produce preforms which are substantially larger than current technology permits. Preforms several orders of magnitude wider and longer than current preform can be easily produced with the present inventive technique with no loss of quality in the resultant fibre or waveguide. These “super” preforms may require several draw downs to produce the fibre.

Another advantage of the present invention is that it opens the possibility for continuous manufacture of crystal fibres. By means of extrusion, the crystal fibre itself or the preform can be continuously produced. The process may involve extrusion of the preform, the preform could be optionally annealed, and then followed by drawing and optionally coating of the optical fibre.

Such drawing may be accomplished using conventional techniques or using performs specifically produced according to the inventive method. For example, in some instances, pressurised gas or liquid may be required within the crystal fibre preform to prevent the air hole collapsing during fibre drawing. Using the aforementioned extrusion technique, such pressurised gas or liquid may already be provided within the preform thereby allowing a seamless connection to a fibre drawing process.

In addition, if at any stage a different holey optical fibre is required, for example with different air hole arrangements, the die for extrusion can be altered. This is particularly important for holey fibres using photonic band gap effect. As will be appreciated by persons skilled in the art, the positioning and shape of the discrete elements, eg air hole is crucial to such photonic band gap holey fibres. The above discussed continuous production technique may be used to rapidly provide the various air hole arrangements allowing easy and rapid testing of various holey fibre structures.

Another advantage of this approach to making holey fibres is that it allows the use of materials that cannot currently be used to make holey fibres. Holey fibres are currently made in silica glass as discussed above. This new technique allows the use of polymers that are polymerised either by bulk polymerisation or by the use of light (eg UV-laser) or other sources. The present invention will also allow the use of polymers made by non-free radical polymerisations, eg condensation polymerisation.

A range of polymers may be used to make the holey fibres or preforms. These are generally those suitable for free radical polymerisation. Specifically polymethylmethacrylate and other methacrylates are common, as are fluorinated analogues. In attempts to achieve lower absorption losses much effort has focused on the use of polymer system which have no C-H bonds. Specifically amorphous Teflons™ (DuPont) and CYTOP™ (Asahi Glass) have been used with some success. All of the above mentioned polymer systems are suitable for the new technique described in this document. The new technique can use monomers, oligomer or polymers, or any combination thereof. Polymerisation, if required, can be achieved via chemical, light enhanced or other means. Rapid polymerisation can be achieved by the use of light sensitive polymerisation aids. Additionally polymerisation aids that control molecular weight, such as chain transfer agents, and cross-linking agents can be used; these have benefits in controlling solution and polymer viscosity, which may be important in the extrusion process and in the drawing of fibre from the preform.

While the thermomechanical forming of monomeric/polymeric/oligomeric materials is well known, there is still an element of empirical analysis which must be done to provide the desired result. Indeed, there are a wide variety of parameters for extrusion and injection moulding of plastic material as discussed below.

PMMA—Extrusion

ATOFINA Chemicals Inc has various PMMA resins suitable for extrusion under the trade mark Atoglas and Plexiglass™. It is recommended that for extrusion of Plexiglass acrylic resins, barrel and die temperatures should be in the region of around 175° C. (350° F.) to around 250° C. (500° F.). Of course, as is clear to persons skilled in the art, these figures will fluctuate depending upon the material which is being extruded, the type and shape of die and the through put.

PMMA—Injection Moulding

For injection moulding of PMMA, mould temperatures around 40 to 80° C. are suggested depending upon the type of mould, with the material temperature should be around 200 to 250° C. As temperature increases, molecular orientation and internal stresses decrease, however, the risk of sink spots increase. Generally high injection pressures are required due to the poor flow properties of PMMA and it may be necessary to slowly inject the material to maintain the correct flow.

Teflon—Injection Moulding and Extrusion

Once again, however, if material other than PMMA is used, different parameters may be required. For example, using Teflon® AF amorphous fluoro polymer resin as supplied by E. I. du Pont de Nemours and Company is suitable for both extrusion and injection moulding.

Teflon® AF can also be formed at relatively low temperatures by extrusion or injection moulding in typical flouro polymer moulding equipment. Teflon® AF 1600 for example, has typical extrusion/moulding temperatures of around 240 to 270° C. (464 to 527° F.) Teflon® AF 2400 has extrusion/moulding temperature of around 340° C. to 360° C. (644° F. to 680° F.) processing above 360° C. is to be avoided since the polymer begins to decompose at this level.

As with PMMA, it is highly desirable to have corrosion resistant tooling for the die and associated equipment. Both Teflon® AF 1600 and 2400 have been shown suitable for fibre optics.

Inorganic Materials

A variety of glasses are available including some proprietary glasses from Schott. It is known in the art that there are special glasses made of a combination of inorganic compounds that have attractive optical properties that cannot be obtained with standard silicate glasses. The invention disclosed herein provides a method suitable for making performs and fibres using these special glasses. Examples of such glasses are chalcogenides, oxides of heavy metals, sulphides of Germanium and Gallium, oxysulfides, halides and chalcohalides.

A typical preform produced by the present invention is shown in FIG. 1. The preform 10 comprises a body of optically suitable material 20 in which there are formed a series of discrete optical elements 30. In this instance, the discrete elements are circular air holes preferably running in a mutually spaced apart array, parallel to the axis of the preform and of constant cross section throughout their length.

As discussed above, however, the number, arrangement, size and shape of the discrete optical elements 30 may vary in accordance with the method and the desired end use of the fibre.

For instance, the micrograph shown in FIG. 2 shows a holey polymer fibre with a similar arrangement of airholes passing therethrough. The defect or light transmissive core 40 can be seen in the middle of the fibre.

FIG. 3 shows a micrograph of a holey fibre with air holes passing therethrough of various different sizes. This fibre acts in a manner similar to a graded index fibre since the different sized air holes passing through the fibre provide a different effective refractive index.

It is envisaged that the above mentioned technique can be applied using conventional injection moulding or extrusion apparatus or leading edge techniques such as micro extrusion, reactive injection moulding.

It will be appreciated by persons skilled in the art that the present invention provides a significant commercial advance over the prior art. Variations and other embodiments of the inventive process and products resulting therefrom may be made without departing from the spirit or scope of the inventive idea.

1. A method of producing a preform for a holey optical fibre, said fibre having one or more light transmitting region(s) therethrough, said method comprising thermomechanically forming said preform from a unitary body of an optically suitable material such that one or more discrete optical elements are formed therein, each element having a refractive index which is different from the refractive index of the optically suitable material.

2. A method as claimed in claim 1, wherein the method produces a preform for a polymer holey optical fibre.

3. A method as claimed in claim 1, wherein the method produces a preform for an inorganic glass holey optical fibre.

4. A method as claimed in any one of claims 1 to 3, wherein the unitary body is fluid.

5. A method as claimed in claim 1, wherein said method further comprises heating said material to obtain said fluid unitary body.

6. A method as claimed in claim 1, wherein said unitary body of optical suitable material is obtained by providing said material in particulate form and melting said material to obtain said fluid unitary body.

7. A method as claimed in claim 1, wherein said preform is formed by extrusion.

8. A method as claimed in claim 1, wherein said preform is formed by injection moulding.

9. A method as claimed in claim 1, wherein the optically suitable material includes a polymeric material.

10. A method as claimed in claim 1, wherein the optically suitable material is a mixture of polymeric and monomeric material mixed together such that, thermomechanically, they act as a single material during formation of the preform.

11. A method as claimed in claim 1, wherein the optically suitable material includes a monomeric material, said method farther comprising a step of polymerisation of said material.

12. A method as claimed in claim 1, wherein the preform is produced with a regular lattice of discrete optical elements.

13. A method as claimed in claim 1, wherein at least some of the discrete optical elements are air holes.

14. A method as claimed in claim 1, wherein at least some of the discrete optical elements are evacuated, filled with fluid or another optical material.

15. A method as claimed in claim 1, wherein at least some of the discrete optical elements include semiconductor materials.

16. A method as claimed in claim 1, wherein at least some of the discrete optical elements include conductive materials.

17. A method of producing a polymer holey optical fibre comprising producing a preform in accordance with claim 1 and drawing said preform to a fibre.

18. A method as claimed in claim 1, wherein the relative cross-sectional position of the discrete optical elements remain constant along the length of the preform or fibre.

19. A method as claimed in claim 1, wherein the relative cross-sectional position of the discrete optical elements varies along the length of the preform or fibre.

20. A method as claimed in claim 1, wherein at least some of the discrete optical elements extend in a mutually spaced apart array, parallel to the axis of the preform or fibre.

21. A method as claimed in claim 1, wherein at least some of the discrete optical elements extend in a helical spiral along the length of the preform or fibre.

22. A method as claimed in claim 1, wherein at least some of the discrete optical elements intersect at various points along the length of the preform or fibre.

23. A method as claimed in claim 1, wherein the cross-sectional size and shape of at least some of the discrete optical elements remain constant along the length of the preform or fibre.

24. A method as claimed in claim 1, wherein the cross-sectional size and shape of at least some of the discrete optical elements vary along the length of the preform or fibre.

25. A method as claimed in any one of claims 17 to 24, wherein, during drawing, said fibre is rotated relative to said preform.

26. A method as claimed in claim 17, wherein production of the preform and drawing of said preform to a fibre is conducted continuously.

27. A method of producing a holey optical fibre comprising thermomechanically altering a unitary body of optically suitable material to form an optical fibre having one or more light transmitting regions including one or more discrete optical elements therein, each optical element having a refractive index which is different from the refractive index of the optically suitable material.

28. A method as claimed in claim 27, wherein the method produces a polymer holey optical fibre.

29. A method as claimed in claim 27, wherein the method produces a inorganic glass holey optical fibre.

30. A method as claimed in any one of claims 27 to 29, wherein the unitary body is fluid.

31. A method as claimed in claim 27, wherein said method further comprises heating said material to obtain said fluid unitary body.

32. A method as claimed in claim 27, wherein said unitary body of optical suitable material is obtained by providing said material in particulate form and melting said material to obtain said fluid unitary body.

33. A method as claimed in claim 27, wherein said fibre is formed by extrusion.

34. A method as claimed in claim 27, wherein the optically suitable material is a polymeric material.

35. A method as claimed in claim 27, wherein the optically suitable material is a mixture of polymeric and monomeric material mixed together such that, thermomechanically, they act as a single material during formation of the fibre.

36. A method as claimed in claim 27, wherein the optically suitable material includes a monomeric material, said method further comprising a step of polymerisation of said material.

37. A method as claimed in claim 27, wherein the fibre is produced with a regular lattice of discrete optical elements.

38. A method as claimed in claim 27, wherein at least some of the discrete optical elements are air holes.

39. A method as claimed in claim 27, wherein at least some of the discrete optical elements are evacuated, filled with fluid or another optical material.

40. A method as claimed in claim 27, wherein at least some of the discrete optical elements include semiconductor or other conductive materials.

41. A method as claimed in claim 27, wherein at least some of the discrete optical elements include conductive materials.

42. A method as claimed in claim 27, wherein the relative cross-sectional position of the discrete optical elements remain constant along the length of the fibre.

43. A method as claimed in claim 27, wherein the relative cross-sectional position of the discrete optical elements varies along the length of the fibre.

44. A method as claimed in claim 27, wherein at least some of the discrete optical elements extend in a mutually spaced apart array parallel to the axis of the fibre.

45. A method as claimed in claim 27, wherein at least some of the discrete optical elements extend in a helical spiral along the length of the fibre.

46. A method as claimed in claim 27, wherein at least some of the discrete optical elements intersect at various points along the length of the fibre.

47. A method as claimed in claim 27, wherein the cross-sectional size and shape of at least some of the discrete optical elements remain constant along the length of the fibre.

48. A method as claimed in claim 27, wherein the cross-sectional size and shape of at least some of the discrete optical elements vary along the length of the fibre.

49. A preform produced in accordance with claim 1.

50. A holey optical fibre produced in accordance with claims 17 or 27.
